(19) United States
(12) Patent Application Publication
(10) Pub. No.: US 2024/0003671 A1
(43) Pub. Date: Jan. 4, 2024

(54) Adaptive Optical Sensing Using Speckle Prediction

(71) Applicant: Apple Inc., Cupertino, CA (US)

(72) Inventors: Mingzhou Jin, San Jose, CA (US); Tong Chen, Fremont, CA (US); William Whitney, Cupertino, CA (US)

(21) Appl. No.: 18/202,813

(22) Filed: May 26, 2023

Related U.S. Application Data
(60) Provisional application No. 63/356,949, filed on Jun. 29, 2022.

(51) Int. Cl. G01B 9/02001; G01B 9/02

(52) U.S. Cl. CPC G01B 9/02001; G01B 9/02092; G01B 9/02094

(57) ABSTRACT

An electronic device including an SMI sensor may be operated to predict interference in an SMI signal caused by speckle provided by the SMI sensor and operate the SMI sensor based on predicted interference in the SMI signal caused by speckle. Predicting interference in the SMI signal caused by speckle and operating the SMI sensor accordingly may allow for accurate measurement of physical phenomena using the SMI sensor with reduced power consumption.

### CROSS-REFERENCE TO RELATED APPLICATION

This application is a nonprovisional and claims the benefit under 35 U.S.C. § 119(e) of U.S. Provisional Patent Application No. 63/356,949, filed Jun. 29, 2022, the contents of which are incorporated herein by reference as if fully disclosed herein.

### TECHNICAL FIELD

Embodiments described herein are related to optical sensing of physical phenomena, and in particular to coherent optical sensing such as self-mixing interferometry (SMI).

### BACKGROUND

Electronic devices such as smart phones may include various sensors, which may sense physical phenomena such as movement, environmental conditions, and biometric data about a user. Additional sensors in electronic devices may provide more robust information to a user and/or unlock additional applications of the device. Given the wide range of applications for sensors in electronic devices, any new development in the configuration or operation of the sensors therein can be useful. New developments that may be particularly useful are developments that provide additional sensing capability, improve the accuracy of sensing physical phenomena, or reduce the cost of sensing.

### SUMMARY

Embodiments described herein relate to systems and methods for adaptive optical sensing based on predicted speckle. In one aspect, a method for operating an electronic device to sense physical phenomena includes generating, by an SMI sensor, an SMI signal; predicting, by processing circuitry, interference in the SMI signal caused by speckle; and operating the SMI sensor based on predicted interference in the SMI signal caused by speckle.

The method may further include emitting electromagnetic radiation from the SMI sensor, wherein the SMI signal is based at least in part on reflections of the emitted electromagnetic radiation. Operating the SMI sensor based on predicted interference in the SMI signal caused by speckle may include adjusting one or more characteristics of the electromagnetic radiation emitted form the SMI sensor based on predicted interference in the SMI signal caused by speckle. For example, emission of electromagnetic radiation may be enabled during a first set of time periods that is predicted to not include interference in the SMI signal caused by speckle, and disabled during a second set of time periods that is predicted to include interference in the SMI signal caused by speckle. Further, one or more of a power of the electromagnetic radiation emitted from the SMI sensor and a waveform of the electromagnetic radiation emitted from the SMI sensor may be adjusted based on predicted interference in the SMI signal caused by speckle.

In one aspect, operating the SMI sensor based on predicted interference in the SMI signal caused by speckle includes adjusting an optic associated with the SMI sensor based on predicted interference in the SMI signal caused by speckle.

The method may further include sampling, by the processing circuitry, the SMI signal. Operating the SMI sensor based on predicted interference in the SMI signal caused by speckle may include adjusting one or more characteristics of the sampling of the SMI signal based on predicted interference in the SMI signal caused by speckle. For example, one or more of a sampling rate of the SMI signal, a sampling window of the SMI signal, and a duty cycle of sampling of the SMI signal may be adjusted based on predicted interference in the SMI signal caused by speckle.

In one aspect, operating the SMI sensor based on predicted interference in the SMI signal caused by speckle includes adjusting one or more characteristics of a post-processing step of the SMI signal based on predicted interference in the SMI signal caused by speckle.

In one aspect, predicting interference in the SMI signal caused by speckle may be based on the SMI signal. Further, predicting interference in the SMI signal caused by speckle may be based on a history of the SMI signal over time.

In an additional aspect, an electronic device may include an SMI sensor and processing circuitry communicably coupled to the SMI sensor. The SMI sensor may be configured to emit electromagnetic radiation and generate an SMI signal based at least in part on reflections of the emitted electromagnetic radiation. The processing circuitry may be configured to predict interference in the SMI signal caused by speckle and operate the SMI sensor based on predicted interference in the SMI signal caused by speckle.

In one aspect, operating the SMI sensor based on predicted interference in the SMI sensor caused by speckle includes adjusting one or more characteristics of the electromagnetic radiation emitted from the SMI sensor. For example, emission of electromagnetic radiation may be enabled during a first set of time periods that is predicted to not include interference in the SMI signal caused by speckle, and disabled during a second set of time periods that is predicted to include interference in the SMI signal caused by speckle. Further, one or more of a power of the electromagnetic radiation emitted from the SMI sensor and a waveform of the electromagnetic radiation emitted from the SMI sensor may be adjusted based on predicted interference in the SMI signal caused by speckle.

In one aspect, the SMI sensor may further include an optic configured to direct the electromagnetic radiation towards a target area. Operating the SMI sensor based on predicted interference in the SMI signal caused by speckle may include adjusting the optic based on predicted interference in the SMI signal caused by speckle.

In one aspect, the processing circuitry may be further configured to sample the SMI signal. Operating the SMI sensor based on predicted interference in the SMI signal caused by speckle may include adjusting one or more characteristics of the sampling of the SMI signal based on predicted interference in the SMI signal caused by speckle. For example, one or more of a sampling rate of the SMI signal, a sampling window of the SMI signal, and a duty cycle of sampling of the SMI signal may be adjusted based on predicted interference in the SMI signal due to speckle.

In one aspect, operating the SMI sensor based on predicted interference in the SMI signal due to speckle includes adjusting one or more characteristics of a post-processing step of the SMI signal based on predicted interference in the SMI signal caused by speckle.

In one aspect, predicting interference in the SMI signal caused by speckle is based on the SMI signal. Further, predicting interference in the SMI signal caused by speckle may be based on a history of the SMI signal over time.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts a block diagram of an electronic device, such as described herein.

FIG. 2 is a graph illustrating an exemplary SMI signal, such as described herein.

FIG. 3 is a flowchart depicting example operations of a method of operating an electronic device to sense physical phenomena, such as described herein.

FIG. 4 is a graph illustrating an exemplary SMI signal, such as described herein.

FIG. 5 is a graph illustrating an exemplary envelope of an SMI signal, such as described herein.

FIG. 6 depicts a functional block diagram illustrating the functional components of processing circuitry to be used with an SMI sensor, such as described herein.

FIG. 7 depicts a block diagram of an electronic device, such as described herein.

The use of the same or similar reference numerals in different figures indicates similar, related, or identical items.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Coherent optical sensing, including Doppler velocimetry and heterodyning, can be used to measure physical phenomena including presence, distance, velocity, size, surface properties, and particle count. Interferometric sensors such as SMI sensors may be used to perform coherent optical sensing. An SMI sensor is defined herein as a sensor that is configured to generate and emit light from a resonant cavity of a semiconductor light source, receive a reflection or backscatter of the light (e.g., light reflected or backscattered from an object) back into the resonant cavity, coherently or partially coherently self-mix the generated and reflected/backscattered light within the resonant cavity, and produce an output indicative of the self-mixing (i.e., an SMI signal). The generated, emitted, and received light may be coherent or partially coherent, but a semiconductor light source capable of producing such coherent or partially coherent light may be referred to herein as a coherent light source. The generated, emitted, and received light may include, for example, visible or invisible light (e.g., green light, infrared (IR) light, or ultraviolet (UV) light). The output of an SMI sensor (i.e., the SMI signal) may include a photocurrent produced by a photodetector (e.g., a photodiode). Alternatively or additionally, the output of an SMI sensor may include a measurement of a current or junction voltage of the SMI sensor's semiconductor light source.

Generally, an SMI sensor may include a light source and, optionally, a photodetector. The light source and photodetector may be integrated into a monolithic structure. Examples of semiconductor light sources that can be integrated with a photodetector include vertical cavity surface-emitting lasers (VCSELs), edge-emitting lasers (EELs), horizontal cavity surface-emitting lasers (HCSELs), vertical external-cavity surface-emitting lasers (VECSELs), quantum-dot lasers (QDLs), quantum cascade lasers (QCLs), and light-emitting diodes (LEDs) (e.g., organic LEDs (OLEDs), resonant-cavity LEDs (RC-LEDs), micro LEDs (mLEDs), superluminescent LEDs (SLEDS), and edge-emitting LEDs (eLEDs)). These light sources may also be referred to as coherent light sources. A semiconductor light source may be integrated with a photodetector in an intra-cavity, stacked, or adjacent photodetector configuration to provide an SMI sensor.

While SMI sensors may be used to accurately sense various physical phenomena, the performance and/or accuracy of sensing physical phenomena thereof may suffer due to speckle of the emitted electromagnetic radiation. Speckle is interference resulting from the constructive and/or destructive addition of reflections or backscatters of the electromagnetic radiation emitted from a coherent light source. In the case of an SMI sensor, speckle may result in random modulation of an envelope of an SMI signal provided therefrom, as well as phase errors on a carrier frequency of the SMI signal. Destructive speckle may result in the envelope of the SMI signal fading below a noise floor, while constructive speckle may result in saturation of the SMI signal. In general, an SMI signal from an SMI sensor may fail to provide useful information for certain periods of time due to interference caused by speckle.

A scanning plan may be used to measure physical phenomena using one or more SMI sensors. A scanning plan may include a power of the electromagnetic radiation emitted from the one or more SMI sensors, a waveform of the electromagnetic radiation emitted from the one or more SMI sensors, a sampling rate of the SMI signals provided from the one or more SMI sensors, a sampling window size of the SMI signals provided from the one or more SMI sensors, and a polling rate (i.e., duty cycle or integration time) of the SMI signals provided from the one or more SMI sensors. Generally, a scanning plan seeks to balance sensing performance (e.g., resolution) with power consumption. For battery-operated electronic devices, this balance may be of particular importance to ensure adequate battery life for a consumer.

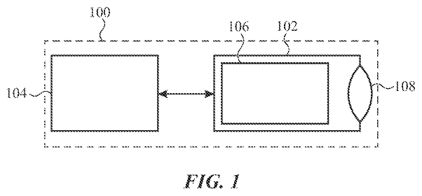

These foregoing and other embodiments are discussed below with reference to FIGS. 1-7. However, those skilled in the art will readily appreciate that the detailed description given herein with respect to these figures is for explanation only and should not be construed as limiting.

FIG. 1 is a block diagram illustrating an electronic device 100 according to one aspect of the present disclosure. The electronic device 100 includes an SMI sensor 102, which is communicably coupled to processing circuitry 104. The SMI sensor 102 includes a radiation source 106 and an optic 108. In operation, the radiation source 106 may generate electromagnetic radiation such as coherent light. The electromagnetic radiation may be emitted towards the optic 108, which directs the electromagnetic radiation towards a desired area. The electromagnetic radiation may be reflected or backscattered back towards the SMI sensor 102, and directed by the optic 108 back towards the radiation source 106. The reflected or backscattered electromagnetic radiation may then self-mix with the generated electromagnetic radiation (e.g., in a self-mixing cavity). This self-mixing may then be measured (e.g., via a junction voltage and/or current of the radiation source or via a photodetector) to generate an SMI signal.

The processing circuitry 104 may operate the SMI sensor 102 to generate the electromagnetic radiation in a desired manner. For example, the processing circuitry 104 may cause the SMI sensor 102 to be driven with a modulated voltage and/or current, which may change the electromagnetic radiation generated and emitted therefrom. Further, the processing circuitry 104 may operate the SMI sensor 102 to generate electromagnetic radiation having a particular waveform, or may operate the optic 108 of the SMI sensor to direct or focus the electromagnetic radiation in a desired manner. Adjusting the electromagnetic radiation generated and emitted from the SMI sensor 102 may result in improved accuracy, signal-to-noise ratio (SNR), or other performance improvements in various scenarios.

The processing circuitry 104 may also sample the SMI signal provided by the SMI sensor 102 in a desired manner. For example, the processing circuitry 104 may sample the SMI signal provided by the SMI sensor 102 at a sampling rate, within a sampling window, and at a sampling duty cycle. The processing circuitry 104 may adjust the sampling rate, sampling window, and sampling duty cycle to achieve a desired accuracy, SNR, or otherwise achieve a desired performance.

As described herein, the terms “processing circuitry” and “processor” refer to any software and/or hardware-implemented data processing device or circuit physically and/or structurally configured to instantiate one or more classes or objects that are purpose-configured to perform specific transformations of data including operations represented as code and/or instructions included in a program that can be stored within, and accessed from, a memory. This term is meant to encompass a single processor or processing unit, multiple processors, multiple processing units, analog or digital circuits, or other suitably configured computing element or combination of elements.

While the electronic device 100 shown in FIG. 1 includes only a single SMI sensor 102 for purpose of simplicity, the principles of the present disclosure apply to electronic devices 100 having any number of SMI sensors. Those skilled in the art will readily appreciate the application of the principles described herein to electronic devices including multiple SMI sensors.

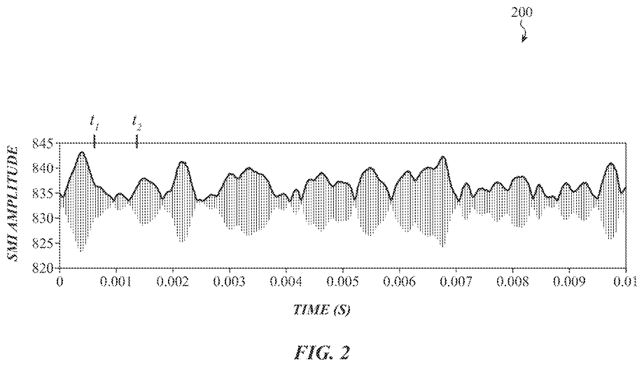

FIG. 2. is a graph 200 illustrating an exemplary waveform of an SMI signal from the SMI sensor 102 according to one aspect of the present disclosure. The x-axis of the graph 200 represents time in seconds, while the y-axis of the graph 200 represents an amplitude of the SMI signal in micro-Amperes (μA). The portion of the SMI signal between time t₁ and t₂ illustrates a fading event, where the amplitude of the SMI signal falls below a noise floor due to speckle (specifically due to destructive interference). As shown in FIG. 2, there are several such fading events throughout the illustrated portion of the SMI signal, however, the present description will discuss a single fading event for purposes of illustration. While not shown, the SMI signal may also experience one or more saturation events due to speckle (specifically due to constructive interference), wherein the SMI signal maxes out or saturates the measurable amplitude range of the signal. Turning back to the time period between t₁ and t₂, the SMI signal is below a noise floor, such that the SMI signal is not providing useful data (i.e., an SNR of the SMI signal is at or below zero). Accordingly, the SMI signal should not be sampled or used during this period of time, or during any other fading and/or saturation events.

To avoid the impact of fading and/or saturation events on the accuracy of measurement of physical phenomena from the SMI sensor 102, the processing circuitry 104 may be operated to continuously sample the SMI signal, ignoring samples that are above or below a threshold value or otherwise meet a criteria associated with fading and/or saturation of the signal. However, operating the electronic device 100 in this manner may result in high power consumption, as the SMI sensor 102 and processing circuitry 104 are still actively operating during the fading and/or saturation events. In an effort to improve power consumption of the electronic device 100 while maintaining or improving accuracy of measurement of physical phenomena from the SMI sensor 102, the processing circuitry 104 may be operated to predict interference in the SMI signal caused by speckle, and the SMI sensor 102 may be operated based on this predicted interference.

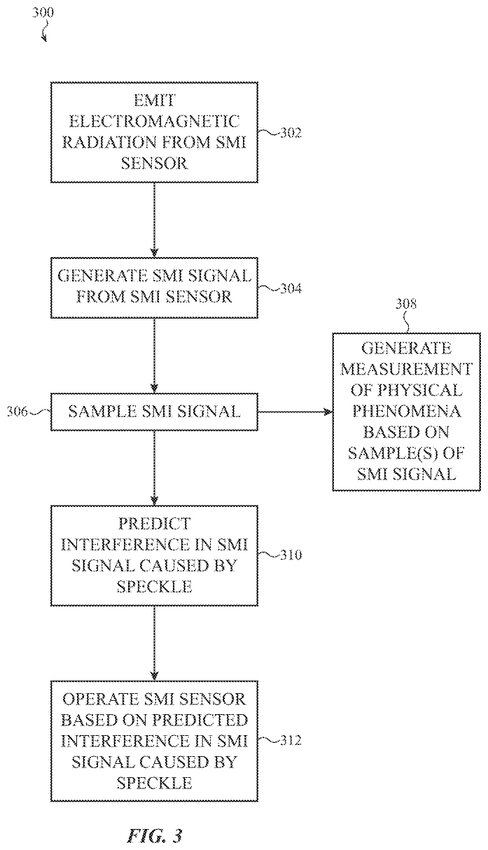

To illustrate these aspects, FIG. 3 is a flow diagram illustrating a method 300 for operating an electronic device, such as the electronic device discussed with respect to FIG. 1, to measure physical phenomena according to one aspect of the present disclosure. Electromagnetic radiation may be emitted from an SMI sensor (step 302) towards a target area. For example, electromagnetic radiation may be emitted from the SMI sensor towards the skin of a user, towards a surface, or towards any other object or system from which it is desired to measure physical phenomena such as presence, distance, velocity, size, surface properties, and particle count. The electromagnetic radiation may be generated having any number of desired characteristics such as a desired power and a desired waveform. An SMI signal may be generated by the SMI sensor (step 304). In particular, the electromagnetic radiation emitted from the SMI sensor may reflect or backscatter from a surface back towards the SMI sensor, self-mix with electromagnetic radiation being generated by the SMI sensor, and the SMI signal may be generated (e.g., by measuring a junction voltage and/or current of a radiation source of the SMI sensor or via a photodetector) that is indicative of the self-mixing. As discussed herein, the SMI signal may include periods of fading and/or saturation due to interference caused by speckle. The SMI signal may be sampled (step 306). The SMI signal may be sampled at a desired sample rate, within a desired sampling window, and at a desired sampling duty cycle. One or more samples from the SMI signal may then be used to generate measurements of physical phenomena (step 308). Generating measurements of physical phenomena from samples of the SMI signal may be accomplished in any suitable manner. For example, one or more mathematical operations may be performed on one or more samples of the SMI signal, or samples of the SMI signal may be provided to a machine learning model which is trained to provide measurements of a physical phenomena based on samples of the SMI signal. Further, samples of the SMI signal may be digitized or de-digitized, converted, or otherwise transformed or processed as part of the generation of measurements of physical phenomena therefrom.

Interference in the SMI signal due to speckle may be predicted (step 310). Predicting interference in the SMI signal due to speckle may be accomplished in any suitable manner. In various aspects, interference in the SMI signal due to speckle is predicted based on current and/or historical values of the SMI signal as sampled. In some aspects, interference in the SMI signal due to speckle may be based on one or more SMI signal parameters such as speckle contrast, which quantifies the number of speckles encountered in a given duration of time, length of correlation, which quantifies how soon (on average) a speckle is passed, level crossing rate, which quantifies how often (on average) envelope fading or saturation is encountered, and average interference duration, which quantifies how long (on average) a period of envelope fading or saturation lasts. First order, higher order, and nonlinear models based on one or more of these parameters, or any other parameters, may be used to predict upcoming fading and/or saturation events, during which action can be taken to both reduce the impact of the events on measurement accuracy as well as save power. Samples of the SMI signal may also be provided to a machine learning model, which may be trained to predict upcoming fading and/or saturation events in the SMI signal.

With this in mind, the SMI sensor can be operated based on predicted interference in the SMI signal caused by speckle (step 312). Operating the SMI sensor based on predicted interference in the SMI signal caused by speckle may include adjusting one or more of a power of the electromagnetic radiation emitted from the SMI sensor, a waveform of the electromagnetic radiation emitted from the SMI sensor, one or more operating characteristics of an optic associated with the SMI sensor (e.g., an aperture, a tilt, a focus, or any other optical characteristic). Operating the SMI sensor based on predicted interference in the SMI signal caused by speckle may also or alternatively include adjusting one or more aspects of sampling of the SMI signal such as one or more of a sampling rate, a sampling window, and a sampling duty cycle. In some aspects, the SMI sensor may be operated to enable emission of electromagnetic radiation during a first set of time periods that is predicted to not include interference in the SMI signal caused by speckle is not predicted, and disable emission of electromagnetic radiation during a second set of time periods that is predicted to not include interference in the SMI signal caused by speckle is predicted. The SMI sensor may be operated to reduce or minimize power consumption during periods of interference caused by speckle. This may in turn significantly reduce the overall power consumption of a system using an SMI sensor to measure physical phenomena. Operating the SMI sensor based on predicted interference in the SMI signal caused by speckle may also include adjusting one or more characteristics of a post-processing operation performed on samples of the SMI signal. For example, it may include adjusting one or more parameters associated with an analog or digital processing circuitry to which samples of the SMI signal are provided.

While discussed with respect to a single SMI sensor, the operations described in the method 300 of FIG. 3 may be extended to apply to any number of SMI sensors. Such operations may be completed serially or in parallel as desired for a particular application.

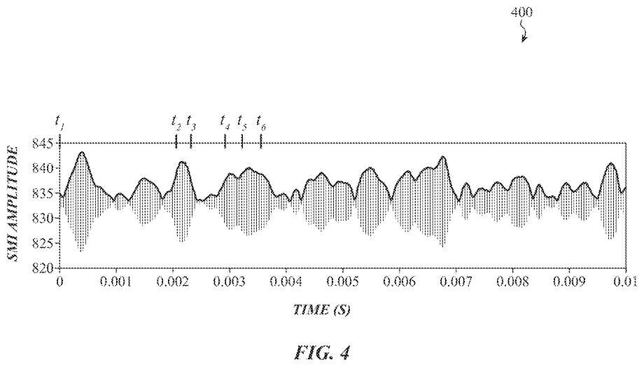

To illustrate these principles, FIG. 4 shows a graph 400 illustrating an exemplary waveform of an SMI signal according to one aspect of the present disclosure. The x-axis of the graph 400 represents time in seconds, while the y-axis of the graph 400 represents an amplitude of the SMI signal in μA. As an example of how interference in the SMI signal caused by speckle may be predicted, certain time periods within SMI signal are marked. In this particular example, from time t₁ to t₂, the SMI signal may be sampled, and the samples may be provided to a prediction model. As discussed above, the prediction model may be a first order, higher order, or nonlinear model based on parameters describing the SMI signal such as speckle contrast, length of correlation, level crossing rate, and average interference duration. Further, in some aspects the prediction model may be a machine learning model. The prediction model may require a minimum number of samples to be initialized, referred to as a learning period, which may be captured in the time period from t₁ to t₂. Alternatively, the prediction model may be based on offline learning or be pre-trained so that it does not require the learning period. From time t₂ to t₃, the prediction model may use samples of the SMI signal to predict an upcoming fading and/or saturation event. At time t₃, the prediction model may predict the occurrence of a fading event. The prediction model may predict that the fading event will last until time t₄. Accordingly, from time t₃ to t₄, the SMI sensor providing the SMI signal may be operated to disable emission of electromagnetic radiation, for example. Further, any other aspects of operation of the SMI sensor providing the SMI signal may be adjusted based on the predicted interference. While a waveform of the SMI signal is shown during the time period from time t₃ to t₄ for purposes of illustration, in reality the SMI signal would not be measured during this time. At time t₄, the SMI sensor may resume normal operation, and the prediction model may be validated against new samples of the SMI signal. During this validation period, which may occur until time t₅, the prediction model may be updated to better predict future interference in the SMI signal caused by speckle. From time is to t₆, the prediction model may resume predicting upcoming interference, which a new fading event being predicted starting at time t₆. While only shown for a first portion of the SMI signal, this process may repeat throughout the remainder thereof.

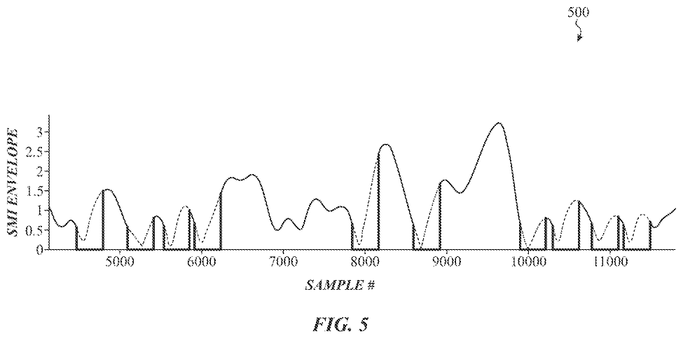

FIG. 5 shows a graph 500 illustrating an exemplary envelope of an SMI signal according to various aspects of the present disclosure. The x-axis of the graph 500 represents number of samples of the SMI signal, while the y-axis of the graph 500 represents an amplitude of the envelope of the SMI signal. Solid portions of the graph line illustrate portions of the SMI signal that were sampled, while dashed portions of the graph line illustrate portions of the SMI signal that were not sampled due to predicted interference in the SMI signal caused by speckle. In the present example, various portions of the SMI signal are not sampled due to fading events. While not shown, portions of the SMI signal may also not be sampled due to saturation events. As discussed herein, the SMI sensor providing the SMI signal may be operated so that it does not generate or emit electromagnetic radiation during the periods where the SMI signal is not sampled, which may significantly reduce power consumption. In the present example, about 70% of the SMI signal is sampled, which may provide an adequate number of samples for accurate measurement of a physical phenomena while also significantly reducing power consumption associated with an SMI sensor from which the SMI signal is provided.

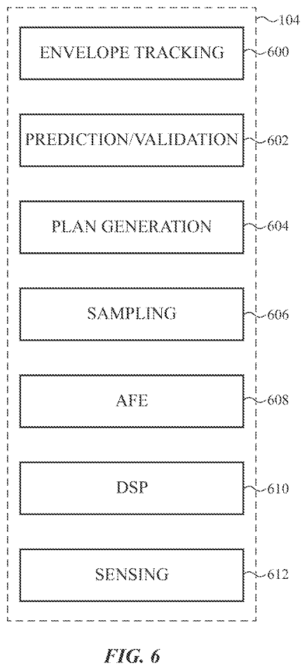

Returning to FIG. 1, the processing circuitry 104 of the electronic device 100 may provide a significant number of functions. Accordingly, FIG. 6 is a functional block diagram illustrating various functional blocks that may be part of the processing circuitry 104 according to various aspects of the present disclosure. The functional blocks depicted as part of the processing circuitry 104 may include the same or different circuitry, but are referred to generally as processing circuitry 104. As shown, the processing circuitry 104 includes envelope tracking circuitry 600, which may track an envelope of the SMI signal provided to the processing circuitry 104 from the SMI sensor 102. The envelope of the SMI signal may be used by prediction and validation circuitry 602 along with any other measurements to predict upcoming interference in the SMI signal caused by speckle, and to validate previously predicted interference. In other words, the prediction and validation circuitry 602 may maintain and operate a prediction model for predicting interference in the SMI signal caused by speckle as described herein. Plan generation circuitry 604 may receive prediction information from the prediction and validation circuitry 602 and generate a scanning plan for the SMI sensor 102. As discussed above, a scanning plan may include a power of the electromagnetic radiation emitted from the SMI sensor 102, a waveform of the electromagnetic radiation emitted from the SMI sensor 102, a sampling rate of the SMI signal generated by the SMI sensor 102, a sampling window size of the SMI signal generated by the SMI sensor 102, and a sampling duty cycle of the SMI signal generated by the SMI sensor 102. The plan generation circuitry 604 may be in communication with the SMI sensor 102 and one or more other functional blocks within the processing circuitry 104 to adjust these aspects.

Sampling circuitry 606 may obtain samples of the SMI signal from the SMI sensor 102. Samples from the sampling circuitry 606 may be provided to analog front end (AFE) circuitry 608 and/or digital signal processing (DSP) circuitry 610, which may demodulate or otherwise process the samples into a desired form. The plan generation circuitry 604 may be communicably coupled to the sampling circuitry 606, the AFE circuitry 608, and the DSP circuitry 610 to adjust one or more operating parameters as discussed herein based on predicted interference in the SMI signal caused by speckle. Sensing circuitry 612 may convert demodulated or otherwise processing samples from the AFE circuitry 608 and/or the DSP circuitry 610 into measurements of physical phenomena. As discussed herein, this may be accomplished in any suitable manner such as by one or more mathematical operations or by a machine learning model.

Notably, the functional blocks discussed with respect to FIG. 6 are merely exemplary. The processing circuitry 104, along with any additional circuitry, may be used to accomplish principles discussed herein in order to reduce the impact of speckle on SMI sensor operation while also reducing power consumption.

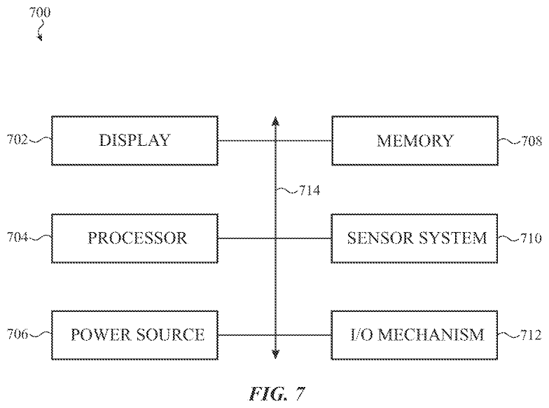

FIG. 7 shows a sample electrical block diagram of an electronic device 700, which may be implemented as the electronic device described in FIG. 1. The electronic device 700 may include an electronic display 702 (e.g., a light-emitting display), a processor 704 (also referred to herein as processing circuitry), a power source 706, a memory 708, or storage device, a sensor system 710, an input/output (I/O) mechanism 712 (e.g., an input/output device, input/output port, or haptic input/output interface). The processor 704 may control some or all of the operations of the electronic device 700. The processor 704 may communicate, either directly or indirectly, with some or all of the other components of the electronic device 700. For example, a system bus or other communication mechanism 714 can provide communication between the electronic display 702, the processor 704, the power source 706, the memory 708, the sensor system 710, and the I/O mechanism 712.

The processor may be implemented as any electronic device capable of processing, receiving, or transmitting data or instructions, whether such data or instructions is in the form of software or firmware or otherwise encoded. For example, the processor 704 may include a microprocessor, central processing unit (CPU), an application-specific integrated circuit (ASIC), a digital signal processor (DSP), a controller, or a combination of such devices. As described herein, the term “processor” or “processing circuitry” is meant to encompass a single processing unit, multiple processors, multiple processing units, or other suitably configured computing element or elements. In some embodiments, the processor 704 may provide part or all of the processing systems, processing circuitry, or processors described with reference to any of FIG. 1.

It should be noted that the components of the electronic device 700 can be controlled by multiple processors. For example, select components of the electronic device 700 (e.g., the sensor system 710) may be controlled by a first processor and other components of the electronic device 700 (e.g., the electronic display 702) may be controlled by a second processor, where the first and second processors may or may not be in communication with each other.

The power source 706 can be implemented with any device capable of providing energy to the electronic device 700. For example, the power source 706 may include one or more batteries or rechargeable batteries. Additionally or alternatively, the power source 706 may include a power connector or power cord that connects the electronic device 700 to another power source, such as a wall outlet.

The memory 708 may store electronic data that can be used by the electronic device 700. For example, the memory 708 may store electrical data or content such as, for example, audio and video files, documents and applications, device settings and user preferences, timing signals, control signals, and data structures and databases. The memory 708 may include any type of memory. By way of example only, the memory 708 may include random access memory (RAM), read-only memory (ROM), flash memory, removeable memory, other types of storage elements, or combinations of such memory types.

The electronic device 700 may also include one or more sensor systems 710 positioned almost anywhere on the electronic device 700. For example, the sensor system 710 may include any and all of the sensors discussed herein with respect to FIG. 1. The sensor system 710 may be configured to sense one or more types of parameters, such as but not limited to: vibration, light, touch, force, heat, movement, relative motion, biometric data (e.g., biological parameters) of a user, air quality, proximity, position, or connectedness. By way of example, the sensor system 710 may include one or more SMI sensors as discussed herein with respect to FIG. 1, a heat sensor, a position sensor, a light or optical sensor, an accelerometer, a pressure transducer, a gyroscope, a magnetometer, a health monitoring sensor, and/or an air quality sensor. Additionally, the one or more sensor systems 710 may utilize any suitable sensing technology, including, but not limited to, interferometric, magnetic, capacitive, ultrasonic, resistive, optical, acoustic, piezoelectric, or thermal technologies.

The I/O mechanism 712 may transmit or receive data from a user or another electronic device. The I/O mechanism 712 may include the electronic display 702, a touch sensing input surface, a crown, one or more buttons (e.g., a graphical user interface “home” button), one or more cameras (including an under-display camera), one or more microphones or speakers, one or more ports such as a microphone port, and/or a keyboard. Additionally or alternatively, the I/O mechanism 712 may transmit electronic signals via a communications interface, such as a wireless, wired, and/or optical communications interface. Examples of wireless and wired communications interfaces include, but are not limited to, cellular and Wi-Fi communications interfaces.

While discussed above with respect to SMI sensors, the principles of the present disclosure apply to any sensors that suffer from interference in the signals therefrom due to speckle. For example, the principles of the present disclosure may apply to any coherent optical sensors and ultrasonic sensors. Those skilled in the art will readily appreciate the application of the principles herein to various types of sensors that suffer from interference due to speckle.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of some embodiments, whether or not such embodiments are described and whether or not such features are presented as being a part of a described embodiment. Thus, the breadth and scope of the present description should not be limited by any of the above-described exemplary embodiments but is instead defined by the claims herein presented.

What is claimed is:

1. A method for operating an electronic device to sense physical phenomena, the method comprising:
generating, by a self-mixing interferometry (SMI) sensor of the electronic device, an SMI signal;
predicting, by processing circuitry of the electronic device, interference in the SMI signal caused by speckle; and
operating the SMI sensor based on the predicted interference in the SMI signal caused by speckle.

2. The method of claim 1, further comprising:
emitting electromagnetic radiation from the SMI sensor; wherein,
the SMI signal is based at least in part on reflections of the emitted electromagnetic radiation; and
operating the SMI sensor based on the predicted interference in the SMI signal caused by speckle comprises adjusting one or more characteristics of the electromagnetic radiation emitted from the SMI sensor based on the predicted interference in the SMI signal caused by speckle.

3. The method of claim 2, wherein operating the SMI sensor based on the predicted interference in the SMI signal caused by speckle comprises:
enabling emission of electromagnetic radiation from the SMI sensor during a first set of time periods that is predicted to not include interference in the SMI signal caused by speckle; and
disabling emission of electromagnetic radiation from the SMI sensor during a second set of time periods that is predicted to include interference in the SMI signal caused by speckle.

4. The method of claim 2, wherein adjusting the one or more characteristics of the electromagnetic radiation emitted from the SMI sensor comprises adjusting one or more of:
a power of the electromagnetic radiation emitted from the SMI sensor; or
a waveform of the electromagnetic radiation emitted from the SMI sensor.

5. The method of claim 1, wherein operating the SMI sensor based on the predicted interference in the SMI signal caused by speckle comprises adjusting an optic associated with the SMI sensor based on predicted interference in the SMI signal caused by speckle.

6. The method of claim 1, further comprising:
sampling, by the processing circuitry, the SMI signal; wherein,
operating the SMI sensor based on the predicted interference in the SMI signal caused by speckle comprises adjusting one or more characteristics of the sampling of the SMI signal based on predicted interference in the SMI signal caused by speckle.

7. The method of claim 5, wherein adjusting the one or more characteristics of the sampling of the SMI signal comprises adjusting one or more of:
a sampling rate of the SMI signal;
a sampling window of the SMI signal; or
a duty cycle of sampling of the SMI signal.

8. The method of claim 1, wherein operating the SMI sensor based on the predicted interference in the SMI signal caused by speckle comprises adjusting one or more characteristics of a post-processing step of the SMI signal based on predicted interference in the SMI signal caused by speckle.

9. The method of claim 1, wherein predicting interference in the SMI signal caused by speckle is based on the SMI signal.

10. The method of claim 9, wherein predicting interference in the SMI signal caused by speckle is based on a history of the SMI signal over time.

11. An electronic device, comprising:
a self-mixing interferometry (SMI) sensor configured to:
emit electromagnetic radiation; and
generate an SMI signal based at least in part on reflections of the emitted electromagnetic radiation; and
processing circuitry communicably coupled to the SMI sensor and configured to:
predict interference in the SMI signal caused by speckle; and
operate the SMI sensor based on the predicted interference in the SMI signal caused by speckle.

12. The electronic device of claim 11, wherein operating the SMI sensor based on the predicted interference in the SMI signal caused by speckle comprises adjusting one or more characteristics of the electromagnetic radiation emitted from the SMI sensor based on predicted interference in the SMI signal caused by speckle.

13. The electronic device of claim 12, wherein operating the SMI sensor based on the predicted interference in the SMI signal caused by speckle comprises:
enabling emission of electromagnetic radiation from the SMI sensor during a first set of time periods that is predicted to not include interference in the SMI signal caused by speckle; and
disabling emission of electromagnetic radiation from the SMI sensor during a second set of time periods that is predicted to include interference in the SMI signal caused by speckle.

14. The electronic device of claim 12 wherein adjusting the one or more characteristics of the electromagnetic radiation emitted from the SMI sensor comprises adjusting one or more of:
a power of the electromagnetic radiation emitted from the SMI sensor; or
a waveform of the electromagnetic radiation emitted from the SMI sensor.

15. The electronic device of claim 11, wherein:
the SMI sensor further comprises an optic configured to direct the electromagnetic radiation towards a target area; and
operating the SMI sensor based on the predicted interference in the SMI signal caused by speckle comprises adjusting the optic based on predicted interference in the SMI signal caused by speckle.

16. The electronic device of claim 11, wherein:
the processing circuitry is further configured to sample the SMI signal; and
operating the SMI sensor based on the predicted interference in the SMI signal caused by speckle comprises adjusting one or more characteristics of the sampling of the SMI signal based on predicted interference in the SMI signal caused by speckle.

17. The electronic device of claim 16, wherein adjusting the one or more characteristics of the sampling of the SMI signal comprises adjusting one or more of:
a sampling rate of the SMI signal;
a sampling window of the SMI signal; or
a duty cycle of sampling of the SMI signal.

18. The electronic device of claim 11, wherein operating the SMI sensor based on the predicted interference in the SMI signal caused by speckle comprises adjusting one or more characteristics of a post-processing step of the SMI signal based on predicted interference in the SMI signal caused by speckle.

19. The electronic device of claim 11, wherein predicting interference in the SMI signal caused by speckle is based on the SMI signal.

20. The electronic device of claim 19, wherein predicting interference in the SMI signal caused by speckle is based on a history of the SMI signal over time.
